(19) United States
(12) Patent Application Publication
(10) Pub. No.: US 2013/0186434 A1
(43) Pub. Date: Jul. 25, 2013

(54) METHOD FOR TREATING UTENSILS WITH CHEMISTRY IN A DISHWASHER

(71) Applicants: KAUSTAV GHOSH, BENTON HARBOR, MI (US); AUSTIN R. GWYNN, VALPARAISO, IN (US); JAMES W. KLEIN, KALAMAZOO, MI (US); STEVEN J. KUEHL, STEVENSVILLE, MI (US); RODNEY M. WELCH, EAU CLAIRE, MI (US); JOHN R. WISNOSKI, HAUBSTADT, IN (US)

(72) Inventors: KAUSTAV GHOSH, BENTON HARBOR, MI (US); AUSTIN R. GWYNN, VALPARAISO, IN (US); JAMES W. KLEIN, KALAMAZOO, MI (US); STEVEN J. KUEHL, STEVENSVILLE, MI (US); RODNEY M. WELCH, EAU CLAIRE, MI (US); JOHN R. WISNOSKI, HAUBSTADT, IN (US)

(73) Assignee: WHIRLPOOL CORPORATION, BENTON HARBOR, MI (US)

(21) Appl. No.: 13/357,992

(22) Filed: Jan. 25, 2012

(51) Int. Cl. B08B 3/08

(52) U.S. Cl. 134/25.2

(57) ABSTRACT

A method for operating a dishwasher having a tub at least partially forming a treating chamber, a sprayer that emits liquid into the treating chamber, and a supply conduit fluidly coupled to the sprayer and through which liquid is supplied to the sprayer from a liquid source, in which heat is applied to utensils by an exothermic reaction.

### BACKGROUND OF THE INVENTION

Dishwashers include a treating chamber in which utensils are placed to be washed according to an automatic cycle of operation. Water, alone, or in combination with a treating chemistry, forms a wash liquid that is distributed to the utensils during the cycle of operation. The wash liquid may be recirculated onto the utensils during the cycle of operation.

Treating chemistry can be dispensed from a dispenser provided on an interior of the door of the dishwasher. Tough soil, such as caramelized carbohydrates and denatured proteins, on utensils are difficult to remove with consistency using conventional dispensers.

### SUMMARY OF THE INVENTION

The invention relates to a method for operating a dishwasher having a tub at least partially forming a treating chamber, a sprayer that emits liquid into the treating chamber, and a supply conduit fluidly coupled to the sprayer and through which liquid is supplied to the sprayer from a liquid source. The method comprises introducing an exothermic chemistry, which is the product of a reaction of at least a first exothermic reactant and a second exothermic reactant, into the treating chamber for treating utensils in the treating chamber by supplying at least the first exothermic reactant through the sprayer, and heating at least some of the utensils within the treating chamber with the exothermic chemistry by the exothermic chemistry dwelling on the at least some of the utensils.

### BRIEF DESCRIPTION OF THE DRAWING(S)

In the drawings:

FIG. 1 is a schematic illustration of an automatic dishwasher according to a first embodiment of the invention;

FIG. 2 is a close-up view of section II of FIG. 1, illustrating an exothermic dispenser of the dishwasher from FIG. 1;

FIG. 3 is a close-up view of an automatic dishwasher according to a second embodiment of the invention, illustrating an exothermic dispenser of the dishwasher;

FIG. 4 is a partial perspective view of the interior of an automatic dishwasher according to a third embodiment of the invention;

FIG. 5 is a close-up view of an automatic dishwasher according to a fourth embodiment of the invention, illustrating an exothermic dispenser of the dishwasher in an open position;

FIG. 6 is a view similar to FIG. 5, illustrating the exothermic dispenser in a closed position and flow through the exothermic dispenser during a pre-wash or pre-soak phase of a cycle of operation;

FIG. 7 is a view similar to FIG. 6, illustrating flow through the exothermic dispenser after a chemistry has dissolved during the pre-wash or pre-soak phase of the cycle of operation; and

FIG. 8 is a view similar to FIG. 7, illustrating flow through the exothermic dispenser during a later phase of the cycle of operation.

### DESCRIPTION OF EMBODIMENT(S) OF THE INVENTION

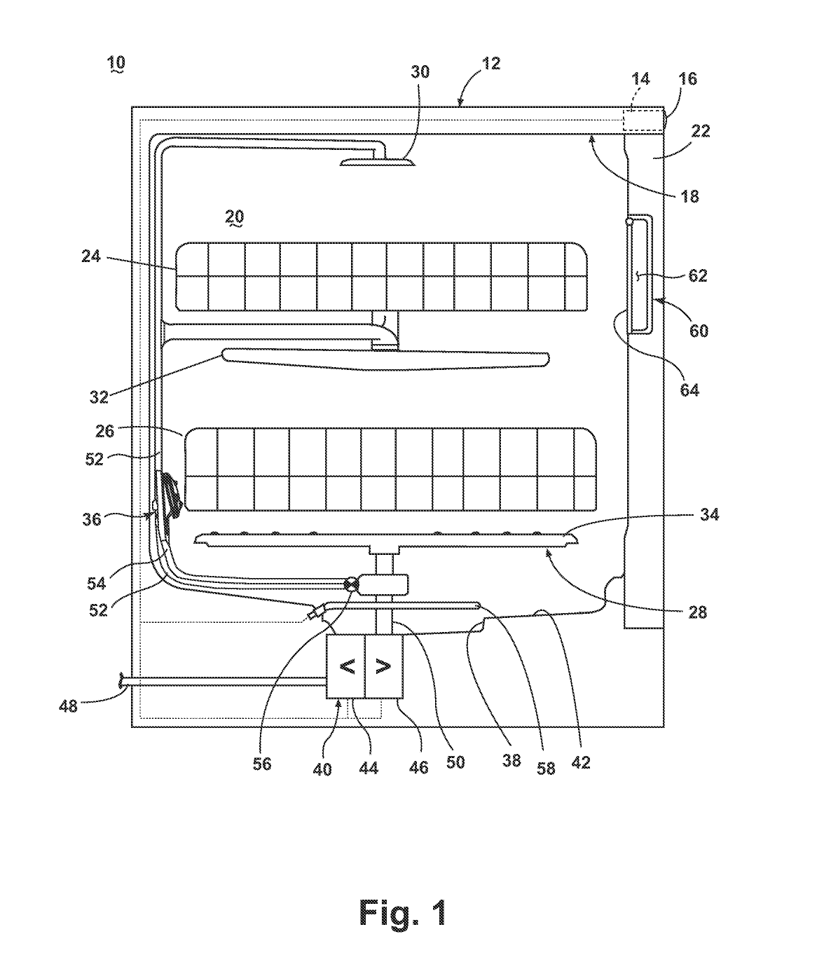

Referring to FIG. 1, a first embodiment of the invention is schematically illustrated as an automatic dishwasher 10 having a cabinet 12 defining an interior. Depending on whether the dishwasher 10 is a stand-alone or built-in, the cabinet 12 may be a chassis/frame with or without panels attached, respectively. The dishwasher 10 shares many features of a conventional automatic dishwasher, which will not be described in detail herein except as necessary for a complete understanding of the invention. While the present invention is described in terms of a conventional dishwashing unit, it could also be implemented in other types of dishwashing units, such as in-sink dishwashers, multi tub dishwashers, or drawer-type dishwashers.

A controller 14 may be located within the cabinet 12 and may be operably coupled to various components of the dishwasher 10 to implement one or more cycles of operation. A control panel or user interface 16 may be provided on the dishwasher 10 and coupled to the controller 14. The user interface 16 may include operational controls such as dials, lights, switches, and displays enabling a user to input commands, such as a cycle of operation, to the controller 14 and receive information.

A tub 18 is located within the cabinet 12 and at least partially defines a treating chamber 20, with an access opening in the form of an open face. A cover, illustrated as a door 22, may be hingedly mounted to the cabinet 12 and may move between an opened position, wherein the user may access the treating chamber 20, and a closed position, as shown in FIG. 1, wherein the door 22 covers or closes the open face of the treating chamber 20.

Utensil holders in the form of upper and lower racks 24, 26 are located within the treating chamber 20 and receive utensils for being treated. The racks 24, 26 are mounted for slidable movement in and out of the treating chamber 20 for ease of loading and unloading. As used in this description, the term “utensil(s)” is intended to be generic to any item, single or plural, that may be treated in the dishwasher 10, including, without limitation: dishes, plates, pots, bowls, pans, glassware, and silverware. While not shown, additional utensil holders, such as a silverware basket on the interior of the door 22 or a third level rack above the upper rack 24, may also be provided.

A spraying system 28 may be provided for spraying liquid into the treating chamber 20 and is illustrated as having multiple sprayers in the form of an upper sprayer 30, a mid-level sprayer 32, a lower rotatable spray arm 34, and a spray manifold 36. The upper sprayer 30 may be located above the upper rack 24 and is illustrated as a fixed spray nozzle that sprays liquid downwardly within the treating chamber 20. Mid-level rotatable sprayer 32 and lower rotatable spray arm 34 are located, respectively, beneath upper rack 24 and lower rack 26 and are illustrated as rotating spray arms. The mid-level spray arm 32 may provide a liquid spray upwardly through the bottom of the upper rack 24. The lower rotatable spray arm 34 may provide a liquid spray upwardly through the bottom of the lower rack 26. The mid-level rotatable sprayer 32 may optionally also provide a liquid spray downwardly onto the lower rack 26, but for purposes of simplification, this will not be illustrated herein.

A liquid recirculation system may be provided for recirculating liquid from the treating chamber 20 to the spraying system 28. The recirculation system may include a sump 38 and a pump assembly 40. The sump 38 collects the liquid sprayed in the treating chamber 20 and may be formed by a sloped or recess portion of a bottom wall 42 of the tub 18. The pump assembly 40 may include both a drain pump 44 and a recirculation pump 46.

The drain pump 44 may draw liquid from the sump 38 and pump the liquid out of the dishwasher 10 to a household drain line 48. The recirculation pump 46 may draw liquid from the sump 38 and pump the liquid to the spraying system 28 to supply liquid into the treating chamber 20. While the pump assembly 40 is illustrated as having separate drain and recirculation pumps 44, 46 in an alternative embodiment, the pump assembly 40 may include a single pump configured to selectively supply wash liquid to either the spraying system 28 or the drain line 48, such as by configuring the pump to rotate in opposite directions, or by providing a suitable valve system. While not shown, a liquid supply system may include a water supply conduit coupled with a household water supply for supplying water to the sump 38.

As shown herein, the recirculation pump 46 has an outlet conduit 50 in fluid communication with the spraying system 28 for discharging wash liquid from the recirculation pump 46 to the sprayers 30-36. As illustrated, liquid may be supplied to the mid-level rotatable sprayer 32 and upper sprayer 30 through a supply conduit 52 and liquid may be supplied to the spray manifold 36 through a manifold supply conduit 54. Both conduits 52, 54 extend generally rearward from the recirculation pump 46 and upwardly along a rear wall of the tub 18. A diverter valve assembly 56 can be provided to selectively control the supply of liquid from the outlet conduit 50 to one of the conduits 52, 54. Additional diverters (not shown) may be provided within the spraying system 28 such that liquid may be selectively supplied to each of the sprayers 30-36. The sprayers 30-36 spray water and/or treating chemistry onto the dish racks 24, 26 (and hence any utensils positioned thereon) to effect a recirculation of the liquid from the treating chamber 20 to the liquid spraying system 28 to define a recirculation flow path.

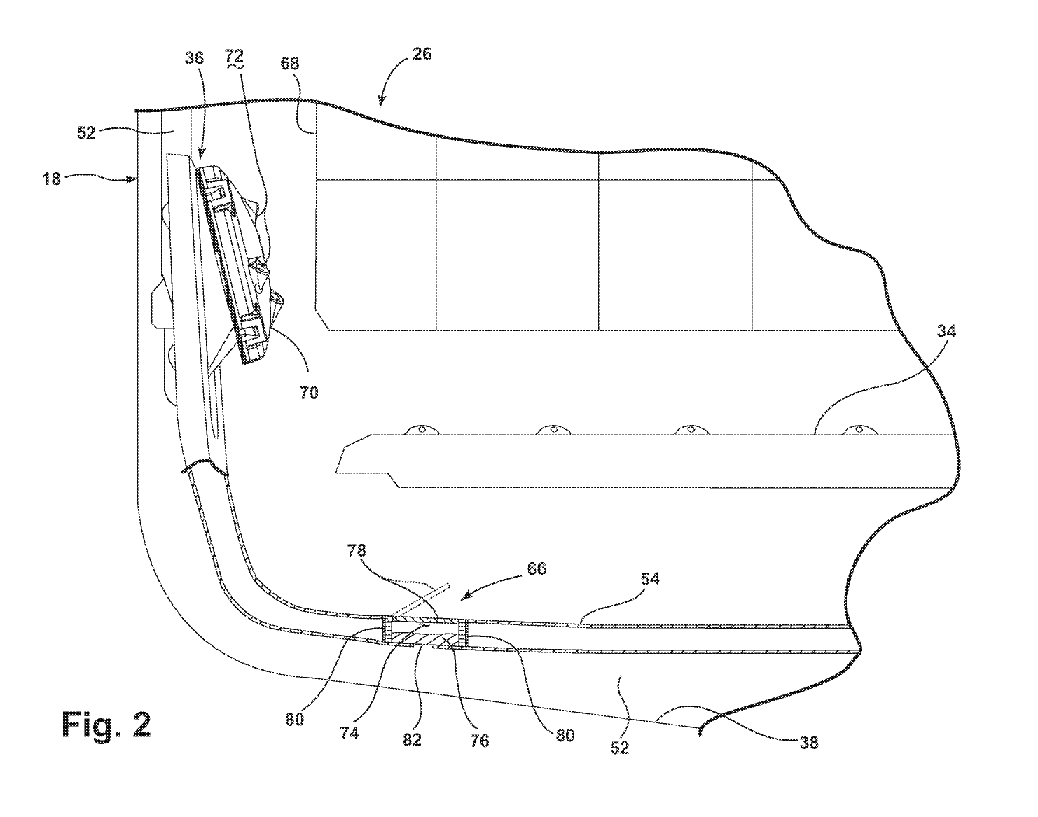

Referring to FIG. 2, the spray manifold 36 may be fixedly mounted to the tub 18 adjacent to the lower rack 26 and may provide a liquid spray laterally through a side 68 of the lower rack 26. The spray manifold 36 may not be limited to this position; rather, the spray manifold 36 may be located in virtually any part of the treating chamber 20. The spray manifold 36 may include multiple spray nozzles or heads 70 having at least one aperture or outlet 72 configured to spray liquid towards the lower rack 26. The spray heads 70 may be fixed or rotatable with respect to the tub 18. Suitable spray manifolds are set forth in detail in U.S. Pat. No. 7,445,013, issued Nov. 4, 2008, and titled “Multiple Wash Zone Dishwasher,” and U.S. Pat. No. 7,523,758, issued Apr. 28, 2009, and titled “Dishwasher Having Rotating Zone Wash Sprayer,” both of which are incorporated herein by reference in their entirety.

Referring back to FIG. 1, a heating system having a heater 58 may be located within or near the sump 38 for heating liquid contained in the sump 38. A filtering system (not shown) may be fluidly coupled with the recirculation flow path for filtering the recirculated liquid.

A wash aid dispensing system may be provided for storing and dispensing treating chemistry to the treating chamber 20. As shown herein, the wash aid dispensing system can include a first dispenser 60 mounted on an inside surface of the door 22 such that the first dispenser 60 is disposed in the treating chamber when the door 22 is in the closed position. The first dispenser 60 is configured to dispense treating chemistry to substantially all utensils within the treating chamber 20, i.e. those utensils in the upper and lower racks 24, 26, as well as in any other utensil racks (not shown). The first dispenser 60 can have one or more compartments 62 closed by a door 64 on the inner surface of the dishwasher door 22.

The first dispenser 60 can be a single use dispenser which holds a single dose of treating chemistry, a bulk dispenser which holds a bulk supply of treating chemistry and which is adapted to dispense a dose of treating chemistry from the bulk supply during a cycle of operation, or a combination of both a single use and bulk dispenser. The first dispenser 60 can further be configured to hold multiple different treating chemistries. For example, the first dispenser 60 can have multiple compartments 62 defining a first chamber in which a single dose of detergent can be held and a second chamber in which a bulk supply of rinse aid can be held. While shown as being disposed on the door 22, other locations of the first dispenser 60 are possible.

Referring to FIG. 2, the wash aid dispensing system can further include a second dispenser 66 that is configured to store and dispense at least one exothermic treating chemistry reactant (or “exothermic reactant”) to the treating chamber 20. The exothermic reactant can react with at least one other exothermic reactant to produce an exothermic treating chemistry. Additional exothermic reactants can also be used. The exothermic treating chemistry can be applied to at least a portion of the utensils within the treating chamber 20 and can release heat which will heat the utensils to which it is applied. The application of the exothermic treating chemistry can include applying the final exothermic treating chemistry product to the utensils, or applying one or more exothermic reactants to the utensils, sequentially or simultaneously, with the exothermic reaction occurring on the utensils themselves.

The second dispenser 66 can be associated with the spraying system 28, such that the exothermic treating chemistry or at least one of its reactants is supplied through at least one of the sprayers 30-36. As shown herein, the second dispenser 66 is associated with the spray manifold 36. The spray manifold 36 can introduce the exothermic treating chemistry into the treating chamber 20 by spraying at least one exothermic reactant. As will be discussed in more detail below, the spray manifold 36 can further spray multiple exothermic reactants into the treating chamber 20.

The second dispenser 66 can be configured to dispense the exothermic treating chemistry to those utensils within a predetermined zone or area of the treating chamber 20. As shown herein, the predetermined zone includes a rear portion of the lower rack 26 that is adjacent to the spray manifold 36. The rear portion of the lower rack 26 within the predetermined zone can have an indicator, such as a unique color or text, which communicates to a user that a utensil placed within that portion of the lower rack 26 can be treated with an exothermic treating chemistry.

The second dispenser 66 can be a single use dispenser which holds a single dose of exothermic treating chemistry or at least one of its reactants, a bulk dispenser which hold a bulk supply and which is adapted to dispense a dose from the bulk supply during a cycle of operation, or a combination of both a single use and bulk dispenser.

The second dispenser 66 can include a chamber 74 for receiving at least one exothermic reactant 76 and a closure 78 for selectively providing access to the chamber 74. As shown, the closure is a pivoting door 78, but other closures, such as a screw-on or snap-on cap, are possible. The chamber 74 can be provided within the manifold supply conduit 54 and can be defined by at least one perforated wall or grill which permits liquid in the supply conduit 54 to flow through the chamber 74 while not substantially impeding the flow of liquid. In the illustrated embodiment, two spaced perforated walls 80 are provided which extend across the diameter of the supply conduit 54. To load the second dispenser 66, the door 78 can be opened (as illustrated in phantom line) and the exothermic treating chemistry or exothermic reactant 76 can be received in the chamber 74, between the walls 80. While only one exothermic reactant 76 is shown in the second dispenser 66, the second dispenser 66 can further be configured to hold multiple different exothermic reactants. For example, the second dispenser 66 can have multiple chambers 74 defining a first chamber in which a first exothermic reactant can be held and a second chamber in which a second exothermic reactant can be held. Furthermore, while shown as being disposed along the bottom of the tub 18, other locations of the second dispenser 66 are possible, such as along a side wall of the tub 18 or within the spray manifold 36, itself.

A drain port 82 can be provided within the supply conduit 54 for draining liquid from the supply conduit 54. In the illustrated embodiment, the drain port 82 is provided as an opening in the sidewall of the supply conduit 54, within the chamber 78. The drain port 82 can be positioned such that the exothermic treating chemistry or exothermic reactant 76 within the chamber 74 will substantially cover or close the drain port 82. As the amount of exothermic treating chemistry or exothermic reactant 76 within the chamber 74 is reduced or used up, such as by the dissolution or solvation of the chemistry or reactant 76, the drain port 82 can be exposed, which effectively opens the drain port 82, allowing liquid to drain out of the supply conduit 54 and into the sump 38, rather than being delivered to the spray manifold 36. With the drain port 82 open, the recirculation pump 46 (FIG. 1) may continue to pump the liquid to the supply conduit 54, but the liquid will not be directed to the spray manifold 36.

In operation, tough soil, including but not limited to caramelized carbohydrates and denatured proteins, on utensils placed within the lower rack 26 can be treated with an exothermic chemistry dispensed using the spray manifold 36. In the first embodiment, water flows through the manifold supply conduit 54 and through the chamber 74 on its way to the spray heads 70. The exothermic reactant 76 in the chamber 74 can be taken up by the water, such as by dissolving in the water, and can, thereby, be delivered to utensils through the spray heads 70. The water supplied through the supply conduit 54 can act as a second exothermic reactant, such that the water mixes with the first exothermic reactant 76 to produce an exothermic reaction on the surface of utensils within the treating chamber 20 and release an amount of heat. Once the exothermic chemistry is activated, i.e. once it begins to give off heat, soil on the utensils can be softened and/or the bond between the soil and the dish surface can be broken.

The second dispenser 66 can be active during a pre-wash or pre-soak phase of a cycle of operation, in which liquid, such as water, is delivered to the spray manifold 36 via the manifold supply conduit 54. After delivery of the exothermic chemistry to the utensils, liquid flow through the spray manifold 36 may be ceased, to prevent dilution and/or flushing away of the exothermic chemistry by excess water. The initial period of time that the spray manifold 36 is active can be predetermined, or gauged based on information from a sensor (not shown) coupled with the controller 14 (FIG. 1). The sensor be positioned to detect when all or a majority of the exothermic reactant 76 has been removed from the chamber 74, and the controller 14 can actuate the diverter valve assembly 56 to stop water flow through the supply conduit 54 upon receiving such a signal from the sensor.

Alternatively, when initially placed in the chamber 74, the exothermic reactant 76 can be configured to act as a seal or closure for the drain port 82. When all or a majority of the exothermic reactant 76 has been removed from the chamber 74, the drain port 82 is exposed, allowing water supplied through the conduit 54 to be drained into the sump 38 prior to reaching the spray manifold 36. Therefore, the spray manifold 36 may be configured to only be active until the drain port 82 is exposed during the pre-wash or pre-soak phase of the cycle of operation. Alternatively, the spray manifold 36 may be configured to be active during other phases of the cycle of operation. For example, the velocity or flow rate of water supplied through the conduit 54 during different phases of the cycle of operation can be changed based on the speed of the recirculation pump 46. During the pre-wash or pre-soak phase, the recirculation pump 46 can be operated at a relatively low speed, such that the velocity or flow rate of water supplied through the conduit 54 is relative low, and the water will drain through the drain port 82 when exposed. After the pre-wash or pre-soak phase, the recirculation pump 46 can be operated at a relatively high speed, such that the velocity or flow rate of water supplied through the conduit 54 is relative high, and no water or a minimal amount of water will drain through the exposed drain port 82.

The exothermic chemistry may remain on the utensils for a predetermined period of time, or dwell time that can be selected to allow the exothermic chemistry to soften the soil and/or break the bond between the soil and the dish surface. The dwell time can depend on the type of soil and the type of exothermic chemistry, and can last up to several minutes, for example, 3-10 minutes. After the dwell time, the spray manifold 36 may be activated to flush away the soil and the exothermic chemistry. During the pre-soak phase, no water may be delivered to the supply conduit 52 in order to prevent dilution and/or flushing away of the exothermic chemistry by water from the sprayers 30-34. Alternatively, such as, but not limited to, when the drain port 82 is exposed by removal of the exothermic reactant 76 from the chamber 74, water may be sprayed from the sprayers 30-34 after the dwell time to flush away the soil and the exothermic chemistry, as well as to wet all of the utensils in the treating chamber 20 in preparation for a washing phase of the cycle of operation.

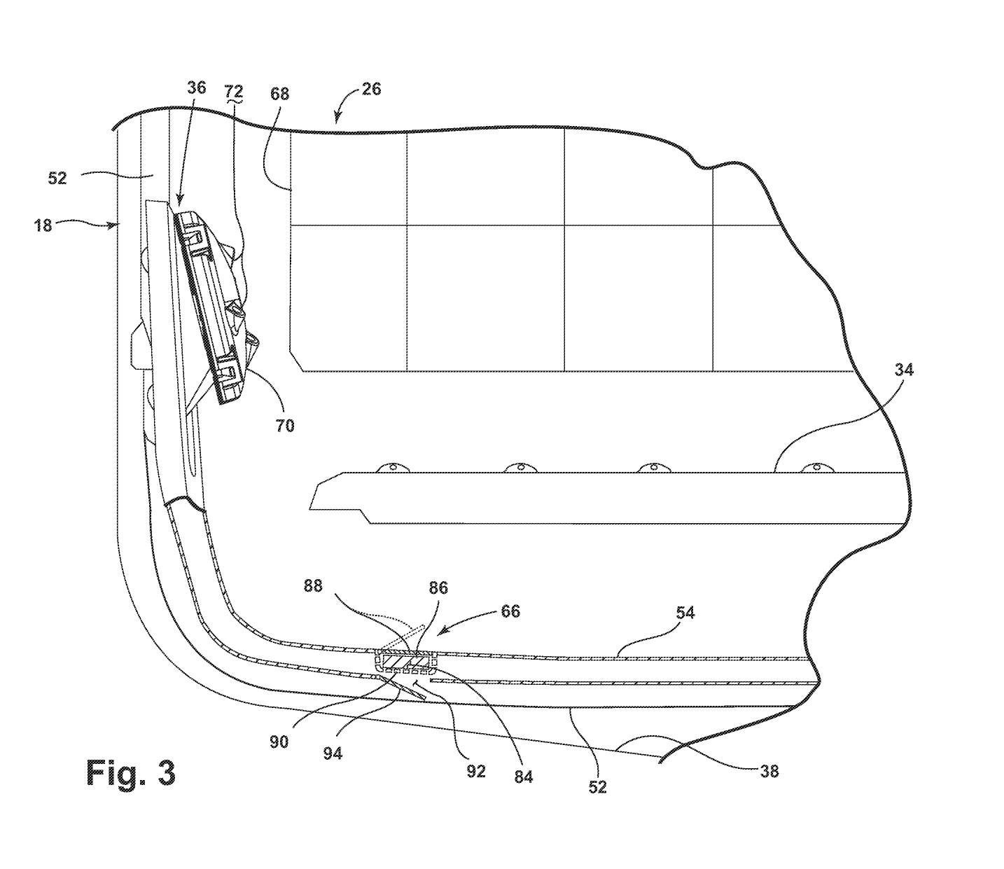

FIG. 3 is a close-up view of a dishwasher 10 according to a second embodiment of the invention. The dishwasher 10 can be substantially similar to the dishwasher 10 of FIGS. 1-2, with the exception of the second dispenser 66. In the second embodiment, the second dispenser 66 includes a chamber 84 for receiving at least one exothermic reactant 86 and a closure 88 for selectively providing access to the chamber 84. As shown, the closure is a pivoting door 88, but other closures, such as a screw-on or snap-on cap, are possible. The chamber 86 can be provided within the manifold supply conduit 54 and can be defined by a perforated compartment or basket 90 which permits liquid in the supply conduit 54 to flow through the chamber 84 while not substantially impeding the flow of liquid. To load the second dispenser 66, the door 88 can be opened (as illustrated in phantom line) and the exothermic treating chemistry or exothermic reactant 86 can be received within the basket 90, in the chamber 84.

A drain port 92 can be provided within the supply conduit 54 for draining liquid from the supply conduit 54. In the illustrated embodiment, the drain port 92 comprises an opening in the sidewall of the supply conduit 54, within the chamber 84, which is selectively closed by a closure member illustrated as a spring-loaded hatch 94. The spring-loaded hatch 94 can be configured to automatically move to an open position (shown in phantom line), thereby, opening the drain port 92, as the exothermic reactant 76 within the chamber 74 is reduced or used up, such as by the dissolution or solvation of the chemistry or reactant 76, allowing liquid to drain out of the supply conduit 54 and into the sump 38, rather than being delivered to the spray manifold 36. For example, the hatch 94 can include a weight-triggered actuator or a weight sensor coupled with an actuator, such that when the weight of the exothermic reactant 76 decreases to a predetermined amount, the hatch 94 will automatically open. With the spring-loaded hatch 94 open, the recirculation pump 46 (FIG. 1) may continue to pump the liquid to the supply conduit 54, but the liquid will not be directed to the spray manifold 36.

In operation, the second embodiment can function in a similar manner as the first embodiment. However, after delivery of the exothermic chemistry to the utensils, liquid flow through the spray manifold 36 may be ceased by actuating the spring-loaded hatch 94 to open the drain port 92, allowing water supplied through the conduit 54 to be drained into the sump 38 prior to reaching the spray manifold 36.

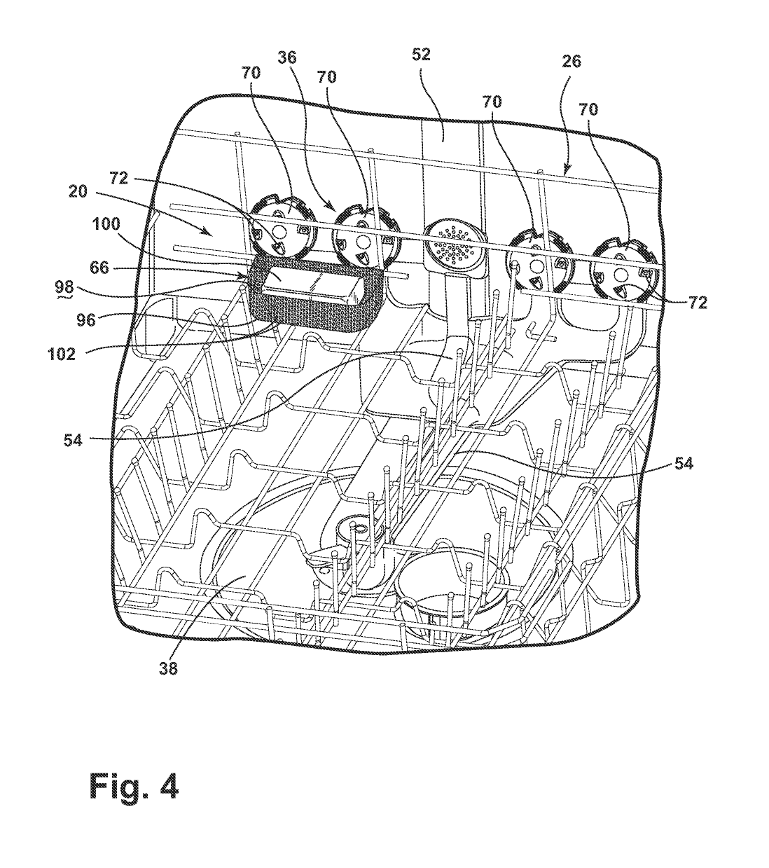

FIG. 4 is a partial perspective view of the interior of an automatic dishwasher 10 according to a third embodiment of the invention. The dishwasher 10 can be substantially similar to the dishwasher 10 of FIGS. 1-2, with the exception of the second dispenser 66. In the second embodiment, the second dispenser 66 is provided within the lower rack 26 and includes an open-top basket 96 defining a chamber 98 for receiving at least one exothermic reactant 100 and having one or more perforations 102 for providing a liquid passage into the chamber 98. The closure 98 can be a pivoting or spring-biased door, but other closures are possible. To load the second dispenser 66, the exothermic reactant 100 is placed into the open-top basket 96 within the chamber 98.

In operation, tough soil, including but not limited to caramelized carbohydrates and denatured proteins, on utensils placed within the lower rack 26 can be treated with an exothermic chemistry dispensed using the spray manifold 36. In the third embodiment, water flows through the manifold supply conduit 54 and through the spray heads 70. The spray of water from the spray heads 70 can flow through the perforations 103 and over the exothermic reactant 100 in the chamber 98 on its path to the utensils, dissolving the exothermic reactant 100 into the spray of water. The water can act as a second exothermic reactant, such that the water mixes with the exothermic reactant 100 in the chamber 98 to produce an exothermic reaction on the surface of utensils within the treating chamber 20 and release an amount of heat. Once the exothermic chemistry is activated, i.e. once it begins to give off heat, soil on the utensils can be softened and/or the bond between the soil and the dish surface can be broken.

The second dispenser 66 can be active during a pre-wash or pre-soak phase of a cycle of operation, in which liquid, such as water, is delivered to the spray manifold 36 via the manifold supply conduit 52. After delivery of the exothermic chemistry to the utensils, liquid flow through the spray manifold 36 may be ceased, to prevent dilution and/or flushing away of the exothermic chemistry by excess water. The initial period of time that the spray manifold 36 is active can be predetermined, or gauged based on information from a sensor (not shown) coupled with the controller 14 (FIG. 1). The sensor be positioned to detect when all or a majority of the exothermic reactant 100 has been removed from the chamber 98, and the controller 14 can actuate a diverter valve assembly (not shown) to stop water flow through the supply conduit 54 upon receiving such a signal from the sensor. After the dwell time, the spray manifold 36 may be re-activated to flush away the soil and the exothermic chemistry. During the pre-soak phase, no water may be delivered to the supply conduit 52 in order to prevent dilution and/or flushing away of the exothermic chemistry by water from the sprayers 30-34. Alternatively, water may be sprayed from the sprayers 30-34 after the dwell time to flush away the soil and the exothermic chemistry, as well as to wet all of the utensils in the treating chamber 20 in preparation for a washing phase of the cycle of operation.

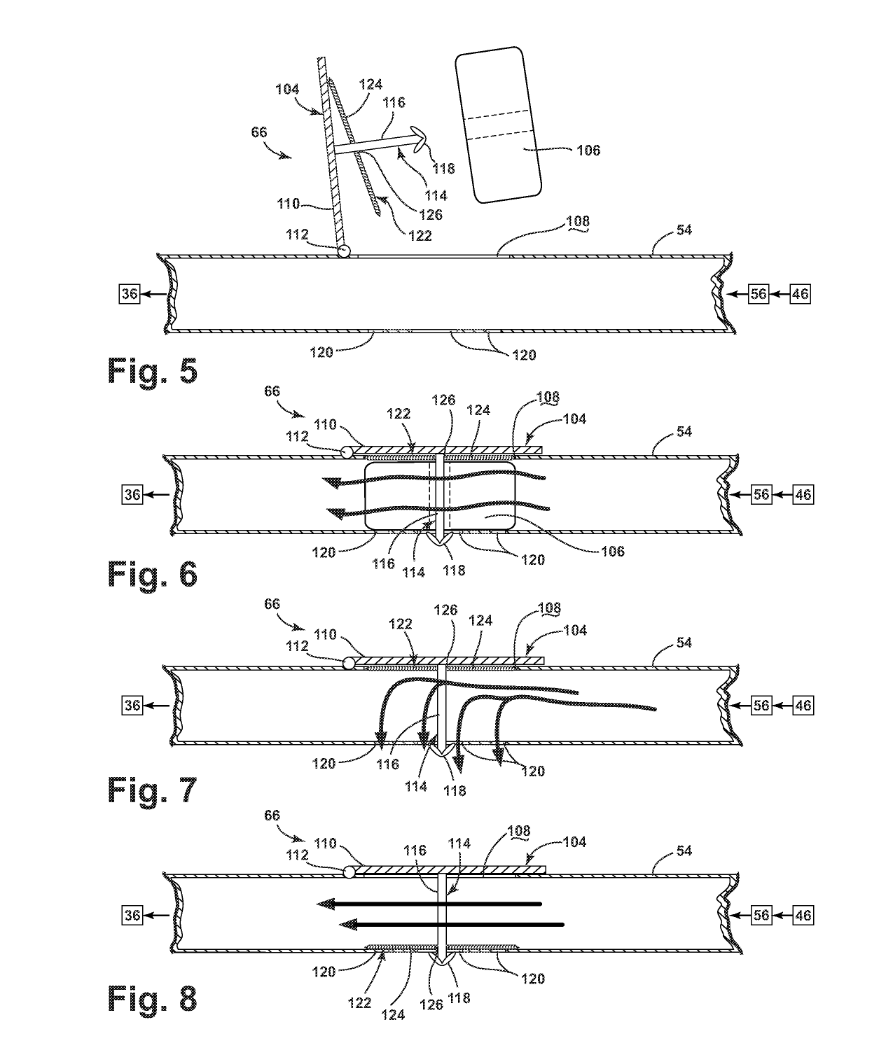

FIG. 5 is a close-up view of a dishwasher 10 according to a fourth embodiment of the invention. The dishwasher 10 can be substantially similar to the dishwasher 10 of FIGS. 1-2, with the exception of the second dispenser 66. In the second embodiment, the second dispenser 66 includes a closure 104 for receiving at least one exothermic reactant illustrated in the form of an annular puck 106 and for selectively providing access to an interior space of the supply conduit 54 via an opening 108. As shown, the closure 104 includes a door 110 and a hinge 112 pivotally attaching the door 110 to the supply conduit 54, but other closures, such as a screw-on or snap-on cap, are possible. The closure 104 further includes a pin 114 for mounting the puck 106 to the door 110. The pin 114 includes a pin shaft 116 attached to an inner side of the door 110 and a pin head 118 on the free end of the pin shaft 116.

One or more drain port(s) 120 can be provided within the supply conduit 54 for draining liquid from the supply conduit 54. In the illustrated embodiment, three drain ports are provided as openings in the sidewall of the supply conduit 54, generally opposite the closure 104, which are selectively closed by a valve 122. The valve 122 can include a drain plug 124 having a central opening 126 which is slidably received on the pin shaft 116. The drain plug 124 can be neutrally buoyant in water and can be configured to neither sink nor rise when water flows through the supply conduit 54. When water does not flow through the supply conduit 54, the drain plug 124 can fall under gravity to its lowest possible point along the pin shaft 116, as explained in more detail below.

To load the second dispenser 66, the closure 104 can be opened, as shown in FIG. 5, and the puck 106 can be mounted to the pin 114, which the valve 122 positioned between the puck 106 and the door 110. The prongs of the pin head 118 can be resilient, with the prongs deflecting to allow the puck 106 to pass over the pin head 118 and springing back to the position shown in FIG. 6, such that the pin head 118 will hold the puck 106 on the pin shaft 116.

Referring to FIG. 6, with the closure 104 closed, the puck 106 is received within the supply conduit 54. The puck 106 can be sized smaller than the interior side of the supply conduit 54, such that water can flow past the puck 106 to the spray manifold 36. With the closure 104 closed and no water flowing through the conduit 54, the drain plug 124 will rest on the top of the puck 106.

Referring to FIGS. 6-8, in operation, the fourth embodiment can function in a similar manner as the first embodiment. However, as the puck 106 dissolves, liquid flow through the supply conduit 54 may hold the drain plug 124 in place, keeping the drain ports 120 open. Referring to FIG. 7, when all or a majority of the puck 106 has been removed, the drain ports 120 are exposed, allowing water supplied through the conduit 54 to be drained into the sump 38 prior to reaching the spray manifold 36. As long as liquid flows through the conduit 54 during the pre-wash or pre-soak phase, the drain plug 124 will be held in place near the closure 104. However, when liquid flow ceases, the drain plug 124 will fall under gravity to the lowermost end of the pin 104, and close the drain ports 120. Referring to FIG. 8, during a later phase of the cycle of operation, such as a wash or rinse phase, the drain plug 124 will be held in place by the liquid flow through the conduit 54, allowing the spray manifold 36 to be used.

The exothermic chemistry used with any embodiment of the invention described herein can be any chemistry suitable for application to utensils that produce an exothermic reaction within the treating chamber and release a relatively large amount of heat, without causing damage to the utensils or dishwasher. Some non-limiting examples of suitable exothermic chemistries are described below.

The exothermic chemistry, can take any form, including foam, liquid or gel. In one embodiment, the exothermic chemistry can be a foam which forms a thick emulsion that is deposited on the surface of utensils. The foam can have good adhesion properties with the utensils, such that the foam will stick or cling to the surface of the utensils for the duration, or a majority of the duration, of the dwell time. Furthermore, the foam can act as an insulation layer on the surface of the utensils; such will reduce dissipation of the heat from the interface between the exothermic chemistry and the surface.

The first exothermic reactant stored within the second dispenser 66 can take any form, including a powder, a solid block or puck, a gel, a gel-filled bead, a liquid, or a compartmentalized combination of other forms mentioned. In addition to taking part in an exothermic reactant, the first exothermic reactant can be a detergent, surfactant, or enzyme. Non-limiting examples of some suitable exothermic reactants which can be stored within the second dispenser 66 and can also act as a detergent, surfactant, or enzyme, and that produce an exothermic reaction when combined with water are listed in Table 1, below. In addition to being used individually, the first exothermic reactant can also comprise a mixture of exothermic reactants from Table 1. It will be understood that the exothermic reactant is not limited to exposure to water to initiate the exothermic reaction; rather, the wash aid dispensing system can be configured to combine the exothermic reactant in the second display 66 with a reactant other than water to initiate the exothermic reaction.

TABLE 1
Example Exothermic Reactants

Potassium hydroxide**
Potassium percarbonate*
Sodium hydroxide**
Sodium percarbonate*
Calcium hydroxide**
Calcium carbonate*
Calcium percarbonate*
Magnesium hydroxide**
Magnesium percarbonate*
Calcium sulfate**
Magnesium sulfate**
Proteases
Alpha-Amylases
Lipases
Polylactic acid
Polyacrylic-acrylamide
*Gas generation can be used for foam generation with surfactants
**Sodium bi-carbonate can be used to provide foaming action

If the first exothermic reactant is fluidic, it can be encased in a film for handling. The film can be structured to dissolve quickly when exposed to water. Some examples of water-dissolvable films include polyvinyl alcohol (PVOH), polyethylene oxide (PEO), polyvinylpyrrolodines (PVP), polyacrylic acids (PAA), acryamides, polysaccaharides, and various cellulose esters such as carboxymethyl cellulose (CMC).

The second exothermic reactant that reacts with the first exothermic reactant stored within the second dispenser 66 can take any form, including a powder, a solid block or puck, a gel, a liquid, or a compartmentalized combination of other forms mentioned. In the embodiments discussed above, the second exothermic reactant is water supplied through the spray manifold 36. The use of water as an exothermic reactant is advantageous, because it uses a substance which is already supplied to dishwashers. Furthermore, the use of the spray manifold 36 to supply the water is advantageous, because it uses the existing structure of the dishwasher 10 to supply the exothermic chemistry to a predetermined location in the dishwasher 10.

The exothermic chemistry can include one or more additional additives or cleaning agents to enhance its overall cleaning affect. A foaming or frothing agent can be included with the exothermic chemistry, such as combined with the first exothermic reactant in the dispenser 66, in order to create a foam or frothed emulsion when combined with water. One example of a suitable foaming agent is bicarbonate. An additional detergent, enzyme, or surfactant can also be included with the exothermic chemistry in order to increase cleaning performance. Some non-limiting examples of added enzymes include protease and amylase.

A tackifier or an anti-redeposition agent can be included with the exothermic chemistry, such as combined with the first exothermic reactant in the dispenser 66 as a coating on the first exothermic reactant, in order to get the exothermic chemistry to cling to the utensils. The tackifier can, for example, be any resin which gives the exothermic chemistry a measurable tack at the initial temperature conditions of the dishwasher 10, which are typically 35 to 49° C. (95 to 120° F.) for a time period sufficient to deliver the exothermic chemistry to the utensils and allow the exothermic chemistry to soften the soil and/or break the bond between the soil and the dish surface (i.e. the dwell time). Some non-limiting examples of tackifiers include starch or gluten, either of which can having a polyglycol carrier, which can also provide stabilization for the first exothermic reactant, polylactic acid, alpha pinene, acrylic, polyterpene resins (such as one selected from the Piccolyte® series available from Pinova). Some non-limiting examples of anti-redeposition agents include polyacrylic acid, a poly(methacrylic acid)-polyacrylic acid copolymer blend, a polyacrylic acid disperant (such as available as Sokalan® PA 30 CL PN from BASF), an acrylic copolymer (such as available as Aucosol™ 425N from Dow), and/or acrylics having a molecular weight greater than 4500 g/mol and a glass transition temperature (Tg) of approximately 60-120° F.

After wetting, the tackifier creates a sticky slurry or emulsion, which can be sprayed on the utensils. The sticky slurry or emulsion sticks to the utensils, and the exothermic chemistry can begin to work on the soil. Once the exothermic chemistry is activated, i.e. once it begins to give off heat, soil on the utensils can be softened, swollen and/or the bond between the soil and the dish surface can be broken. Rinsing with water quickly dissolves the tackifier, allowing the detergent-laden, loosened soil to be flushed away.

Alternatively, the exothermic chemistry can include one or more shear thinning resin(s) or other component(s) that, when sprayed, is in a low shear state and flows freely. After contacting the utensils, the static shear becomes significantly higher, resulting in the exothermic chemistry clinging to the soil on the utensils until the exothermic chemistry is removed by a shear stress, such as by a spray of water from the spraying system 28.

The exothermic chemistry can be configured to undergo a delayed reaction, so that heat is not produced immediately upon mixing the first and second exothermic reactants. For example, with respect to the first or second embodiment of the dispenser 66, the exothermic chemistry can be configured to react on a slower scale such that heat is not produced until the mixture of water and the exothermic reactant 76, 86 has been sprayed from the spray manifold 36 and is on the utensils in the lower rack 26.

### Example

Table 2, below, gives one example of a composition suitable for use as the first exothermic reactant in the dishwasher 10. The composition can be stored within the second dispenser 66 and reacted with water to create an exothermic reaction that will give off heat.

TABLE 2
Example Composition

| | | More Specific |
|---|---|---|
| | Concentration | Concentration |
| | Range | Range |
| Ingredient | (wt. % solids) | (wt. % solids) |
| Water | 30-60 | 36-50 |
| Anti-redeposition agent(s) | 5-15 | 7-13 |
| Sodium Citrate^{†} | 1-40 | 35-50* |
| Soda Ash or | 1-40 | |
| Calcium/sodium/magnesium | | |
| carbonate^{†} | | |
| Metal Hydroxide (sodium, | 1-40 | |
| potassium, and/or calcium | | |
| hydroxide), dry^{†} | | |
| Chelator such as: | 5-20 | |
| ethylenediaminetetraacetic | | |
| acid (EDTA) | | |
| trisodium salt of | | |
| methylglycinediacetic acid | | |
| (available as Trilon ® M | | |
| from BASF) | | |
| a copolymer of methyl vinyl | | |
| ether and maleic acid | | |
| (available as Gantrez ® S-95 | | |
| from Ashland Inc.) | | |
| Sodium/potassium or silicate | 1-10 | 2-8 |
| Surfactant such as: | 1-7 | 1-2.5 |
| alcohol alkoxylate | | |
| (available as Plurafac ® | | |
| SLF-180 from BASF or | | |
| Triton ™ CF-10 from Dow) | | |
| polyethylene | | |
| nonphenylether (available as | | |
| Igepal ® CO-530 from Stepan) | | |
| Acrylic or other tackifier(s) | 1-20 | 5-15 |
| Enzyme + stabilization package | 0-4% total | 1-2 |
| (mixture of boron compounds | | |
| and ethylene glycols) | | |

^{†}exothermic reactant
*Total combined concentration. Exact concentrations of the individual components can be adjusted in order to meet glass, silverware and other utensil cleaning needs, such as avoidance of glass etching, minimum of spotting and filming and soil removal performance criteria.

With the exception of the metal hydroxide (sodium/potassium/calcium hydroxide) ingredient in Table 2, all of the aforementioned components would be premixed into an aqueous suspension, and then dried to a dry powder form. The enzyme component can be separately dried using a different method, then blended back into the formulation in a later or separate step using methods common in the art. When the formulation is sufficiently dry, the metal hydroxide can be blended onto the powder.

The powder can be introduced into the dishwasher 10 by a user when desired, using any of the dishwasher's dispensers. At the start of a pre-wash or pre-soak cycle, water from the manifold supply conduit 52 can contact the powder formulation and form sticky particles that can be dispersed by the spray from the spray manifold 36 and adhere to the surface of utensils in the lower rack 26. The cycle can be programmed to then stop spraying water, allowing the sticky particles to remain undisturbed on the utensils for a dwell time. As the metal hydroxide(s) and carbonates come in contact with water, an exothermic reaction occurs, increasing the temperature of the sticky particles on the utensil surface. Further, the added enzymes, when they encounter their respective target soil (such as proteins for protease and starches for amylase) would also generate heat as a by-product of the enzymatic reaction. The tackifier(s) can adhere the powder onto the utensil for a sufficient time so as to allow for heating the soil on the utensil, as well as for exposing the soil to the detergent components.

The method and apparatus disclosed herein provides a dishwasher with the capability of treating tough soils on utensils. One advantage that may be realized in the practice of some embodiments of the described systems and methods is that utensils can be treated with an exothermic chemistry, which will undergo an exothermic reaction when exposed to water that will give off heat. The addition of heat when treating soils, especially tough soils, is helpful, because a user does not have to prewash, rewash, and/or hand-wash utensils with tough soils. The high performance of the dishwasher 10 can increase the user's trust in the dishwasher 10 to clean tough soils, leading to further decreases in prewashing and hand-washing.

Another advantage that may be realized in the practice of some embodiments of the described systems and methods is that the use of the exothermic chemistry allows heat to be applied to soils without the need for increased power usage, such as would be required with operating a heater to heat water or air.

Another advantage that may be realized in the practice of some embodiments of the described systems and methods is that the exothermic chemistry can be selected to foam on the utensils. The foam can have at least some structure or stiffness, which will help the exothermic chemistry stay on the utensils while emitting heat to the utensils.

Another advantage that may be realized in the practice of some embodiments of the described systems and methods is that tough soils, including denatured proteins and starches, can be treated with a pre-soak cycle in which a treating chemistry is applied to a localized area of the treating chamber in which a user can place utensils with tough soils.

While the invention has been specifically described in connection with certain specific embodiments thereof, it is to be understood that this is by way of illustration and not of limitation. Reasonable variation and modification are possible within the scope of the forgoing disclosure and drawings without departing from the spirit of the invention which is defined in the appended claims.

1. A method for operating a dishwasher having a tub at least partially forming a treating chamber, a sprayer that produces an emission of liquid into the treating chamber, and a supply conduit, the supply conduit fluidly coupled to the sprayer, and through which liquid is supplied to the sprayer from a liquid source, the method comprising:
introducing an exothermic chemistry, which is the product of a reaction of at least a first exothermic reactant and a second exothermic reactant, into the treating chamber for treating utensils in the treating chamber by supplying at least the first exothermic reactant through the sprayer; and
heating at least some of the utensils within the treating chamber with the exothermic chemistry by the exothermic chemistry dwelling on the at least some of the utensils.

2. The method of claim 1, wherein the supplying at least the first exothermic reactant comprises supplying liquid from the liquid source, with the liquid comprising the first exothermic reactant.

3. The method of claim 2, further comprising preheating the liquid by flowing liquid from the liquid source into the treating chamber, where the liquid source is a hot water supply.

4. The method of claim 3, wherein preheating the liquid comprises bypassing the supply conduit.

5. The method of claim 2, wherein the mixing of the exothermic reactants comprises spraying the liquid from the sprayer toward a chemistry chamber positioned within the treating chamber and configured to hold at least one dose of the second exothermic reactant.

6. The method of claim 5, wherein the dishwasher further comprises a rack for holding utensils and the chemistry chamber is positioned in the rack, such that spraying the liquid from the sprayer toward the chemistry chamber comprises spraying the liquid from the sprayer toward the rack.

7. The method of claim 2, further comprising mixing the first exothermic reactant with the second exothermic reactant in the supply conduit.

8. The method of claim 7, further comprising supplying the second exothermic reactant to the supply conduit to form the exothermic chemistry prior to emission from the sprayer.

9. The method of claim 8, wherein the second exothermic reactant is supplied to a chemistry chamber, the chemistry chamber fluidly coupled to the supply conduit, and the supplied liquid flows through the chemistry chamber.

10. The method of claim 9, wherein the liquid comprises water forming the first exothermic reactant.

11. The method of claim 10, wherein the second exothermic reactant comprises at least one of: potassium hydroxide, potassium percarbonate, sodium hydroxide, sodium percarbonate, calcium hydroxide, calcium carbonate, calcium percarbonate, magnesium hydroxide, magnesium percarbonate, calcium sulfate, magnesium sulfate, a protease, an alpha-amylase, a lipase, polylactic acid, and polyacrylic-acrylamide.

12. The method of claim 7, wherein the mixing of the liquid and the second exothermic reactant comprises dissolving at least some of the second exothermic reactant in the liquid.

13. The method of claim 12, further comprising opening a drain port in the supply conduit after introducing the exothermic chemistry into the treating chamber.

14. The method of claim 13, wherein opening the drain port comprises dissolving at least a portion of the exothermic chemistry to expose the drain port.

15. The method of claim 1, wherein introducing the exothermic chemistry comprises forming a foam in the treating chamber.

16. The method of claim 15, wherein the foam forms an insulation layer to reduce dissipation of the heat from the interface between the exothermic chemistry and the utensil surface.

17. The method of claim 1, wherein the sprayer comprises a spray manifold, the spray manifold fluidly coupled to multiple rotating spray heads, with each spray head having at least one outlet, and the emission comprises spraying from the rotating spray heads.

18. The method of claim 1, further comprising introducing liquid into the treating chamber for rinsing the exothermic chemistry from utensils in the treating chamber.

19. The method of claim 1, further comprising draining the liquid from the supply conduit after introducing the at least one of the exothermic reactants.

20. The method of claim 19, wherein draining liquid comprises opening a port in the supply conduit.
